(19) United States
(12) Patent Application Publication
(10) Pub. No.: US 2022/0269959 A1
(43) Pub. Date: Aug. 25, 2022

(54) FORECASTING APPARATUS, FORECASTING METHOD, AND PROGRAM

(71) Applicant: OSAKA UNIVERSITY, Osaka (JP)

(72) Inventors: Yasuko SAKURAI, Osaka (JP); Yasushi SAKURAI, Osaka (JP)

(21) Appl. No.: 17/629,388

(22) PCT Filed: Jul. 30, 2020
(86) PCT No.: PCT/JP2020/029178

§ 371 Date: Jan. 23, 2022

(30) Foreign Application Priority Data
Aug. 1, 2019 (JP) 2019-142295

(51) Int. Cl. G06N 5/04

(52) U.S. Cl. CPC G06N 5/04

(57) ABSTRACT

A forecasting apparatus includes: a regime update unit configured to perform optimization processing that applies a candidate regime θ to an event stream in a most recent current window Xc, and adjusts a parameter of a model M of the applied regime to reduce a difference from an event; a forecasting unit configured to use the model subjected to the optimization processing by the regime update unit to forecast future event information; and a storage that stores transition information that indicates transition history between regimes. The regime update unit determines whether or not the regime θ being applied satisfies a transition condition, and if the determination is affirmative, uses the transition information for the regime being applied that is stored in the storage to let the regime transition from θ1 to θ2.

### TECHNICAL FIELD

The present invention relates to forecasting techniques that forecast one or more pieces of event information for future in real time using some current windows in a data stream.

### BACKGROUND ART

Currently large amounts of time-stamped data are generated and collected by many advanced technologies and services such as IoT and Web access history. One of the most fundamental demands for marketing and other data science and engineering is to implement an efficient and effective analysis of big time-series data streams, such as real-time and long-term forecasting, without human intervention.

Patent Literature 1 and Non-Patent Literature 1 propose methods and apparatuses for forecasting event values in real time through analysis of time-series data. According to these documents, the forecasting apparatus is configured so that a regime update means reduces a difference between data of a current window in a time-series data stream and an event value of the current window obtained using a mathematical model identified by a parameter set to determine a mathematical model, and a forecasting means then outputs future event values using the determined mathematical model. In particular, this forecasting apparatus uses an adaptive non-linear dynamical system to capture important features or latent trends from a data stream for future time-series data forecasting in a continuous manner for a long period.

### CITATION LIST

### Patent Literature

[Patent Literature 1] WO2018/012487

### Non Patent Literature

[Non-Patent Literature 1] Y. Matsubara et al, Christos Faloutsos: “AutoPlait: Automatic Mining of Co-evolving Time Sequences”, ACM SIGMOD Conference, pp. 193-204, Snowbird, Utah, June 2014.

### SUMMARY OF INVENTION

### Technical Problem

The forecasting method and apparatus described in Patent Literature 1 and Non-Patent Literature 1 use an adaptive non-linear dynamical system to optimize the parameters of the mathematical model for each regime that has been captured in advance, and determine in real time which regime best fits the real time-series data stream input to the current window for accurate future forecasting based on the optimized mathematical model. These method and apparatus still have to be improved in the responsiveness in regime shifts, for example.

Meanwhile, Hidden Markov models (HMM) and other dynamic statistical models or a Bayesian network (BN) probabilistic model have been known as the conventional analysis approaches to time-series data.

However, these approaches are stochastic and discrete, and thus cannot describe dynamic and continuous activities or forecast future dynamic patterns. Also, pHMM and AutoPlait are based on HMM, and have the ability to capture the dynamics of sequences and perform segmentation. However, they are not designed to capture long-range non-linear evolutions. Data-driven, non-linear forecasting methods, such as SMiLer and F4, tend to provide results that are hard to interpret, and are incapable of modeling dynamic patterns in streams.

Traditional modeling and forecasting approaches typically use linear methods, such as autoregressive integrated moving average (ARIMA), and linear dynamical systems (LDS), Kalman filters (KF) as well as AWSOM, TBATS, LiF and TriMine. Note that these methods are fundamentally unsuitable for the use; they are all based on linear equations, and are thus incapable of modeling data governed by non-linear equations. Similarly, the switching state space model, and the switching Kalman filter (SKF) model are designed as a combination of the hidden Markov model with a set of linear dynamical systems. They can handle multiple distinct patterns in time series, but are not intended to capture dynamic space transitions. Thus they cannot model continuous and deterministic behavior between multiple regimes. RegimeCast focuses on the real-time forecasting of event streams, but is not intended to perform regime identification and segmentation. Moreover, it cannot capture transitions between different dynamic patterns.

Deep learning has become one of the most popular methodologies in data analysis tasks, but it has not been speeded up for forecasting. Recurrent neural networks (RNNs) encounter difficulties in modeling long-range dependencies. Long short-term memory (LSTM) and gated recurrent units (GRUs) alleviate this problem, however all DNN variants require a prohibitively high computation cost, especially training cost, for data stream analysis, which is hard to forecast in real time. In addition, most of them require sensitive parameter tuning. In short, none of the existing methods focuses specifically on the modeling and forecasting of the non-linear dynamics of co-evolving multiple patterns in data streams.

In view of the above, the present invention provides forecasting apparatuses, forecasting methods and programs with higher responsiveness, adaptability and accuracy by introducing transition information between regimes.

### Solution to Problem

A forecasting apparatus according to the present invention includes: a regime update unit configured to perform optimization processing that applies a candidate regime to an event stream in a most recent current window, and adjusts a parameter of a model of the applied regime to reduce a difference from an event; a forecasting unit configured to use the model subjected to the optimization processing by the regime update unit to forecast future event information; and a storage that stores transition information that indicates transition history between regimes. The regime update unit determines whether or not the regime being applied satisfies a transition condition, and if the determination is affirmative, uses the transition information for the regime being applied that is stored in the storage to let the regime transition.

A forecasting method according to the present invention includes: a regime updating step of performing optimization processing that applies a candidate regime to an event stream in a most recent current window, and adjusts a parameter of a model of the applied regime to reduce a difference from an event; a forecasting step of using the model subjected to the optimization processing by the regime updating step to forecast future event information; and a storage step of storing transition information that indicates transition history between regimes. The regime updating step determines whether or not the regime being applied satisfies a transition condition, and if the determination is affirmative, uses the transition information for the regime being applied that is stored in the storage to let the regime transition.

A program according to the present invention makes a computer function as the forecasting apparatus.

According to these aspects of the invention, the regime update unit performs optimization processing that applies a candidate regime to an event stream in a most recent current window, and adjusts a parameter of a model of the applied regime to reduce a difference from an event; the forecasting unit uses the model subjected to the optimization processing by the regime update unit to forecast future event information; and the storage stores transition information that indicates transition history between regimes. Then, the regime update unit determines whether or not the regime being applied satisfies a transition condition, and if the determination is affirmative, uses the transition information for the regime being applied that is stored in the storage to let the regime transition. Therefore, a regime change (shift) is made using transition information that indicates the transition history between the regimes stored in advance, which improves responsiveness, adaptability and accuracy of (regime) forecasting between different regimes. As a result, responsiveness and accuracy for future forecasting are improved.

### Advantageous Effects of Invention

The present invention introduces transition information between regimes and thus allows forecasting process with higher responsiveness, adaptability and accuracy.

### BRIEF DESCRIPTION OF DRAWINGS

FIG. 1 shows a snapshot illustrating an example of the regime shift concept of the present invention.

FIG. 2 shows a snapshot of analysis and forecasting at the current time tc according to one embodiment of the present invention.

FIG. 3 describes the modeling of a causal relationship (transitions between regimes) applied to the present invention.

FIGS. 4A, 4B, 4C, and 4D show the modeling power of OrbitMap for a motion sensor stream, where FIG. 4A shows that the model fits the original stream very well, FIG. 4B shows snapshots that identify regimes and their transition points, i.e., segments, FIG. 4C shows snapshots that find dynamic space transitions at various time points, and FIG. 4D are snapshots of lₛ-ahead future values forecasted at three different time points.

FIG. 5 is a block diagram of a forecasting apparatus according to one embodiment.

FIGS. 6A, 6B, and 6C are diagrams illustrating the proposed model, where FIG. 6A is for a single regime, FIG. 6B is for two regimes, and FIG. 6C is for a set of regimes={θ1, . . . , θ5}.

FIG. 7 is a snapshot of the orbit at time point tc.

FIG. 8 shows the forecasting error of OrbitMap for Factory-worker in a motion data stream.

FIG. 9 shows the average forecasting error of OrbitMap and its competitors for eight datasets (#1)-(#8).

FIG. 10 compares OrbitMap with its competitors algorithms in terms of computation time at each time point tc.

FIG. 11 shows the average computation time at each time point for eight datasets (#1)-(#8).

FIGS. 12A, 12B, 12C, and 12D show operational monitoring, especially a four-dimensional IoT sensor stream in a semiconductor fabrication plant.

FIGS. 13A, 13B, 13C, and 13D show engine monitoring, showing a four-dimensional IoT sensor stream.

### DESCRIPTION OF EMBODIMENTS

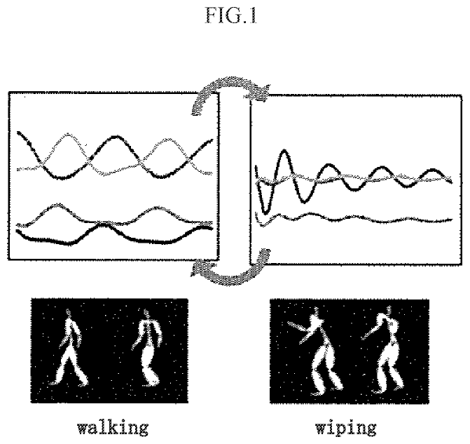

Referring to FIG. 1, the following first describes regimes and regime shifts. A regime represents a characteristic time-series pattern that occurs in a natural phenomenon in environmental ecology, and may refer to a similar time-series pattern. A regime shift represents a phenomenon of transition from one regime to another. A regime shift occurs mainly due to internal factors (e.g., variation of stability in a system) and external factors (e.g., external shocks applied to the system). As shown in the motion data stream on the horizontal time axis in FIG. 1, the time-series data stream has time-series patterns (walking, wiping) that are regimes. A regime shift (walking wiping) on an event stream can be used to improve the forecasting accuracy. In particular, the time series data can be represented for an adaptive non-linear dynamical system similar to Patent Literature 1, whereby a complicated time series pattern can be flexibly represented. Specifically, upon receiving a large-scale time-series data stream, its latent pattern can be represented with a mathematical model including non-linear elements, as described later. Then, parameters (e.g., the initial value) are changed except for the non-linear parameter, so as to adjust (optimize) the mathematical model in an adaptive manner using a non-linear dynamical system while maintaining representation of the latent pattern due to the non-linear elements. This enables high-precision forecasting based on a data stream in the real world.

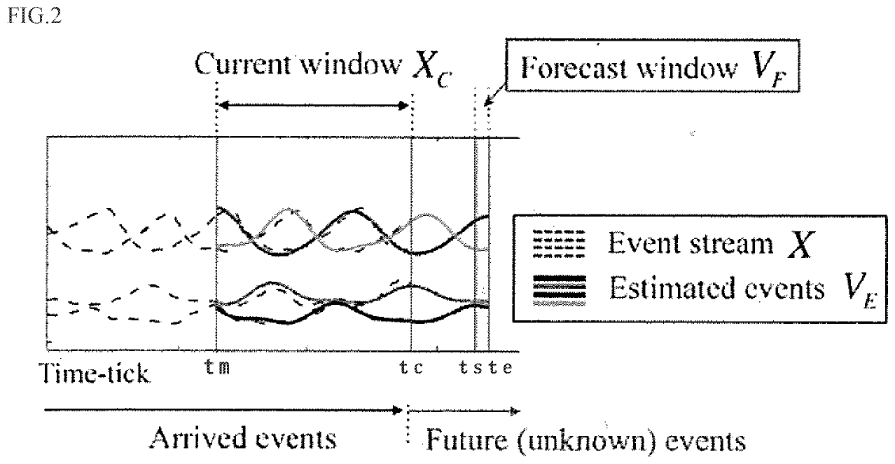

FIG. 2 shows a snapshot at the current time t_{c}, which is visualized to explain the relationship between the event stream X and the current window Xc, which is the basis of the present invention. In the drawing, the dashed line indicates the original event stream X (including the time-series data stream). In FIG. 2, the event stream is configured as a d=4 dimensional event sequence. The bold line represents the event estimated value V_{E} in a time range from the time tick tₘ up to the time tick tₑ. Here, the partial sequence from the time tick t_{c} to the time tick tₑ is a future (i.e., unknown) event set. The present invention continues to estimate these time-series patterns at high speed and continuously. When the original stream X (dashed line) is given, the present invention captures the latest time-series patterns included in the current window Xc (specifies regimes and optimizes the mathematical models) using an adaptive non-linear dynamical system, estimates a current-time time-series pattern V_{E} (bold line), and continuously outputs lₛ-step-ahead future events V_{F} (surrounded by a rectangle) from the current time tick t_{c} at high speed. The lₛ step refers to the output unit time, which may have a different time width depending on the application target.

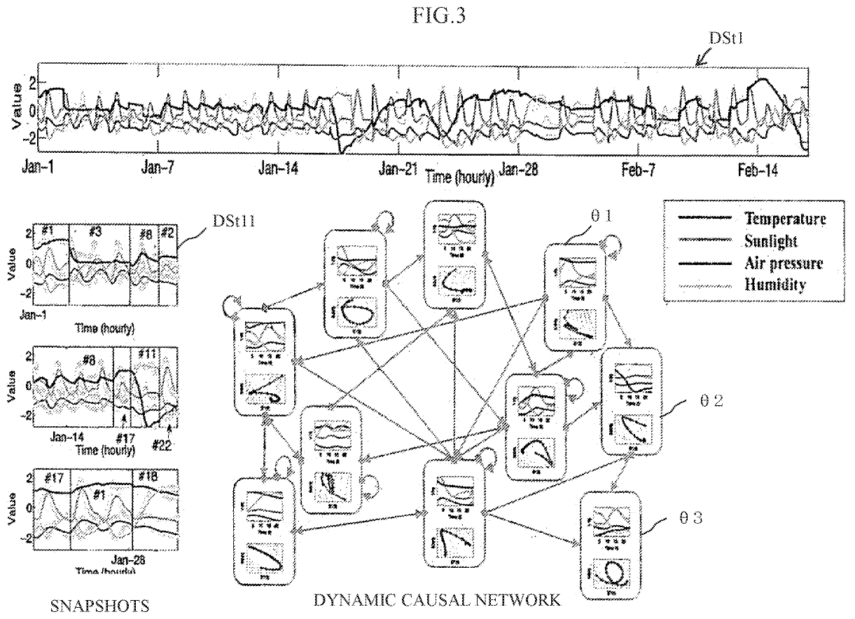

Next, FIG. 3 describes the modeling of a causal relationship (transitions between regimes) applied to the present invention. In the drawing, the top part shows a time-series data stream DSt1 from one or more sensors, the left part shows snapshots of partial stream DSt11 and the subsequent partial streams that are segmented around the time axes January 1, January 14, January 28 as an example, and the middle part illustrates the identification of regimes (regimes θ1, θ2, θ3, . . . ) and the dynamic causal network of their transitions. In this example, the sensor data are temperature, sunshine, atmospheric pressure, and humidity in a factory. This dynamic causal network is called a transition network and shows the history (trajectory/orbit) of changes in regime. For example, the historical relationship of regimes θ1 to θ3 in the drawing indicates that these regimes occur continuously in the order of θ1→θ2→3.

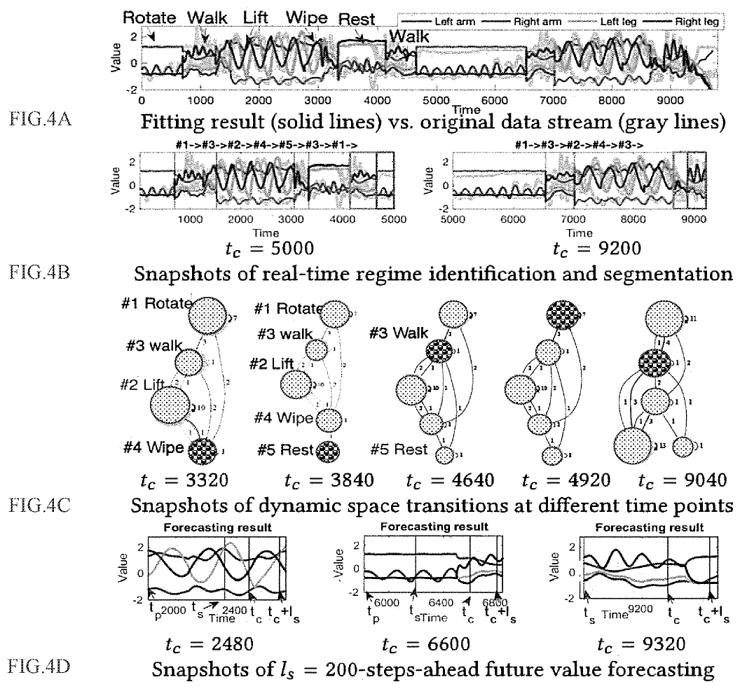

FIGS. 4A, 4B, 4C, and 4D show the modeling power of OrbitMap for a motion sensor stream. In this drawing, FIG. 4A shows that the model fits the original stream very well, FIG. 4B shows snapshots that identify regimes and their transition points, i.e., segments, FIG. 4C shows snapshots that find dynamic space transitions at various time points, and FIG. 4D are snapshots of lₛ-ahead future values forecasted at three different time points.

In the given sensor stream as shown in FIG. 4A and FIG. 4B, typical transitions (e.g., #1 rotation, #3 walking, #2 lifting) and their transition points (segments) are automatically identified from FIG. 4C.

FIG. 4C shows snapshots of the transition network between regimes. In the drawing, each node surrounded with a circle represents a regime included in the data stream, and each edge (chain) between the nodes indicates that a transition occurs between the two regimes. A larger node indicates a higher frequency of occurrence, which may include a larger number of occurrences, and a thicker edge represents a stronger relationship. The leftmost figure in FIG. 4C is composed of four nodes and shows the regime shift at tc=3320. The three figures in the center and one figure on the right show how they grow at different points in time. Further, for the two nodes shown in dark and light colors (FIG. 4C), the leftmost figure shows the two recent regimes at the current time with #4 and #2, for example. This example indicates that the node #2 corresponding to lifting and the node #4 corresponding to wiping are in a transitional relationship. Importantly, the transition network evolves over time as a new regime occurs in the data stream (e.g., at tc=3840, a transition network is newly constructed with the node #5 “Rest”).

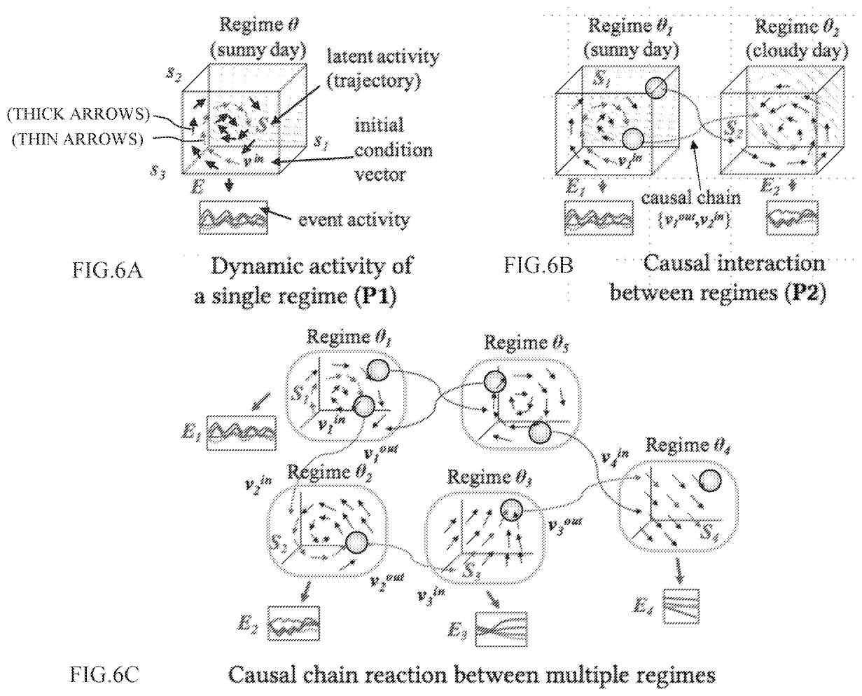

FIG. 4D shows future forecasted snapshots of lₛ=200 step ahead from three different time points. Variables estimated by this method are shown in bold (the original is shown in light). The vertical axes tp, is indicate the recent transition points of regime, and the vertical axes tc, tc+lₛ indicate the current and the future of lₛ step ahead. This method forecasts future regime transitions and generates long-range future values gradually, continuously, and automatically. Unlike Markov chain model and Bayesian networks based on discrete and stochastic modeling and other existing dynamic modeling method, this method uses latent non-linear differential to acquire a dynamic, continuous, and numerical time-series pattern. The function of dynamic space transition between regimes will be explained referring to FIGS. 6A, 6B, and 6C.

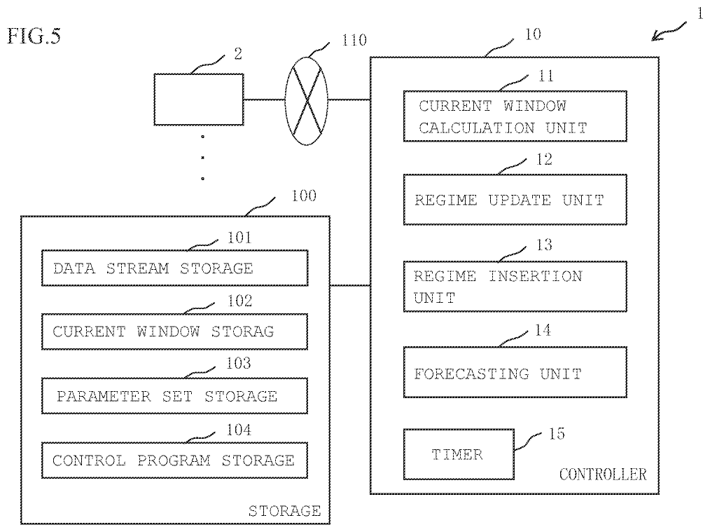

FIG. 5 is a block diagram of a forecasting apparatus 1 according to the present embodiment. In this example, the forecasting apparatus 1 includes a controller 10 made up of a computer equipped with a CPU (processor) and a storage 100 connected to the controller 10. The controller 10 is connected to one or a plurality of sensors 2 (for example, Internet of Things (Iot)-compatible type) via a network 110 so as to be communicable via wire or wireless. The network 110 can be a wide area network, a LAN, or an ordinary communication line. Various types of sensors 2 can be used depending on the application, which may be various sensing members or a sensor having a browser function capable of capturing required information from other external databases on the Web. The storage 100 includes a control program storage 104 storing a processing program to execute the functions as the forecasting apparatus 1.

The controller 10 executes a control program read in a main memory (RAM), which is not shown, from the control program storage 104 to function as a current window calculation unit 11, a regime update unit 12, a regime insertion unit 13, a forecasting unit 14, and a timer 15 for timekeeping. The forecasting apparatus 1 can be various types of personal computers or a mobile terminal. The processing program or necessary data may not be stored in the forecasting apparatus 1, and may be stored in an external memory, such as in a cloud server. They may be downloaded and used when necessary. The controller 10 may include an output unit that outputs the processing status and processing results as needed. Preferably the output unit is a display unit that displays a moving image such as a snapshot.

The storage 100 is a storage medium capable of updating data. The storage 100 includes: in addition to the control program storage 104, a data stream storage 101 storing sensor data from each sensor 2 as a time-series data stream under the control of the controller 10; a current window storage 102 storing a data string of a subsegment that is the latest current window X_{c} generated from the time-series data stream; and a parameter set storage 103 storing a complete parameter set M in an updatable manner, the complete parameter set M including parameters of the mathematical model of each regime, and the dynamic space transition information (transition information) between one or multiple stages of regimes.

The current window calculation unit 11 generates a current window X_{c} from a continuously input time-series data stream, and writes the generated current window Xc to the current window storage 102.

The regime update unit 12 executes various processes as described below, and adjusts the parameters of the mathematical model (model) of a candidate regime for the data stream of the current window Xc to optimize the parameters so that the distance between the estimated value of the model and the original variable is minimized. The regime update unit 12 performs forecasting to obtain one or more event values in the future a predetermined time ahead based on the optimized model. The regime update unit 12 also determines whether or not the candidate regime matches determination conditions, and if it does not match, changes to another regime as needed. The regime update unit 12 also determines whether or not a transition condition between regimes (e.g., transition strength ρ) is exceeded during the execution of a latent sequence in the candidate regime. If it is exceeded, the regime update unit 12 performs processing to use information of the complete parameter set M described later and transition to a corresponding (or phase) position (see FIGS. 6A, 6B, and 6C) in the corresponding regime in accordance with the information of a predetermined, that is, pre-registered “regime pair” and its “transition vector pair”. Every time the regime transitions, the regime update unit 12 updates information on the transition history (trajectory, orbit) in the complete parameter set M.

The regime insertion unit 13 executes various processes as shown below, and determines whether or not a candidate regime matches a condition, and when the candidate regime does not match because it is an unknown new regime, the regime insertion unit 13 creates this new regime as a new pattern. The regime insertion unit 13 further acquires the transition information and the transition vector pair information of one or multiple stages of regime pairs before and after it, and additionally updates the complete parameter set M containing the information in the parameter set storage 103. Note here that the regime insertion unit 13 determines whether or not all the registered regimes match the condition (whether they are consistent), and determines whether or not the target regime is a new unknown pattern.

The complete parameter set M including transition information between regimes (regime pairs), transition vector sets ν including transition vector pairs indicating transition positions between regimes, and occurrence frequency, which may include the number of occurrences, is stored in the parameter set storage 103 in an updated fashion. Every time a regime matches the condition, the occurrence frequency is incremented and updated. The dynamic space transition information between regimes includes at least the transition information between regimes (regime pairs), while the transition vector pair information does not necessarily have to be essential, and may be used depending on the need or application. In the embodiment in which the information of the transition vector pair is indispensable, the transition accuracy is further improved. In addition, preferably, the regime insertion unit 13 automatically performs cleanup process described later as necessary to appropriately eliminate the accumulated old information.

The forecasting unit 14 calculates lₛ-step-ahead future values based on the optimized model parameter calculated and optimized by the regime update unit 12 for each time tc. The forecasting unit 14 outputs and displays their snapshots to the display unit, if necessary.

FIGS. 6A, 6B, and 6C illustrate the spatial visualization of a proposed model. FIG. 6A illustrates, given a single regime and an initial condition vector, the state of generating a latent variable S={s(t)}t (thin arrow) and an estimated variable E={e(t)}t, where k=3, d=4. FIG. 6B illustrates, given two regimes θ1 and θ2 and a transition vector pair {v_{z}^{out}, v₂ⁱⁿ}, the state of generating two sets of estimation variables E1→E2. FIG. 6C illustrates, assuming a set of regimes={θ1, . . . , θ5} and their transition vector set ν, the state of causing multiple space transitions and generating a long-range pattern, that is, E1→E2→E3→E4. Assume that the data stream contains several different regimes, and they have dynamic space transitions with causal relationships. The following describes the example model.

The following describes the dynamics (P1) of time evolution in the case of a single regime. FIG. 6A shows how a single regime model evolves (changes) over time. Such a basic model has the following properties.

Regime dynamic model θ: Each regime has its own dynamic latent space (indicated by thick and thin arrows in the regime of FIG. 6A), which can be described by a nonlinear differential equation.

FIGS. 6A, 6B, and 6C plot only k=3 dimensions for visualization. This model assumes two time evolution sequences.

Latent variable s(t): a k-dimensional latent vector at time t (i.e., s(t)={si(t)}^{k}ᵢ₌₁), which evolves over time as a dynamic system. S=(s(1), . . . , s(t)) is referred to as a “trajectory of the latent space,” or the latent sequence indicated by the thin arrows, as illustrated in FIG. 6A.

Estimated variable e(t): a d-dimensional vector at time point t (i.e., e(t)={ei(t)}^{d}ᵢ₌₁), which can be calculated by s(t). Let E be the estimated sequence, E={e(1), . . . , e(t)}. The estimated sequence E is an estimated value of the original sequence X={x(1), . . . , X(t)}. The estimated sequence E can be any kind of data sequence, such as a d-dimensional sequence generated by d sensors. The regime dynamics model can also use the initial condition vector vⁱⁿ to generate a specific time-series data sequence.

Sequence generation using the initial condition vector vⁱⁿ: Given the regime dynamic model θ and the initial condition vector vⁱⁿ, the regime θ generates a latent/estimated sequence, that is, S={s(1), . . . , s(t)}, E={e(1), . . . , e(t)}. Here, the condition is s(1)=vⁱⁿ, and vⁱⁿ is a k-dimensional vector in the latent space. This means that a dynamic model of a single regime can be described by mathematical expressions.

### Model 1

Let s(t) and e(t) be the latent and estimated variables at time t. In this case, a single regime is described by the equations of the following Mathematical 1.

$$\begin{matrix}[ Mathematical 1 ] & \\ \frac{d s ( t )}{d t} = p + Q s ( t ) + 𝒜 S ( t ) & ( 1 ) \\ e ( t ) = u + V s ( t ) & ( 2 )\end{matrix}$$

The initial condition is s(1)=vⁱⁿ.

In the equations, ds(t)/dt is a derivative for time t. S(t) shows the quadratic form matrix of s(t), that is, S(t)=s(t)^{T}s(t).

Here, p, Q, and A denote latent variables s(t) representing linear, exponential, and non-linear dynamics, respectively, and u and V denote observation projections that generate estimated variable e(t) at each time point t. Also, vⁱⁿ is a k-dimensional initial condition vector in the latent space. As a result, the regime dynamic model θ is defined as a parameter set of a single regime, that is, θ={p, Q, A, u, V}.

Dynamic space transition between multiple regimes (P2): The above shows how a single regime θ is used to generate dynamically time-evolving latent, estimated sequences S, E. Next, the following describes how dynamic transitions (shifts) can be generated between multiple regimes, such as “θ1: jogging→θ2: cooling down→3: resting”.

Here, latent relationships between multiple regimes are described using deterministic, numerical and continuous time-series modeling approach unlike Markov chain models and other existing discrete and stochastic modeling approaches. As this new concept, dynamic space transitions between regimes (P2) is introduced.

FIG. 6B shows how OrbitMap generates estimated variables for two different regimes (e.g., E1→E2). That is, this adds information with the concept of “transition” between two different regimes to connect two different dynamic latent spaces. In this model, each regime θi has its specific transition vectors vᵢⁱⁿ and vᵢ^{out} in the latent space and is connected with other regimes via a space transition network (causal chain). To simplify the explanation, assume a space transition between two regimes θi and θj, and let {vᵢ^{out}, vⱼⁱⁿ} ∈V be an out/in transition vector pair from θi to θj. This model has the following transition rules:

The regime θi generates its own latent variables si(t) at each time point t, according to Model 1. This generation process continues until a space transition from regime θi to another regime θj occurs.

If the trajectory/orbit of the latent variable Si of regime θi gets close to the transition vector vᵢ^{out} at time point ts (when it is determined that the transition condition has been reached), it moves to θj and generates the j-th regime's latent variable, starting with the initial condition sj (ts)=vⱼⁱⁿ. Note that ts is referred to as a transition point.

Here, the space transition from θi to θj occurs, only when the latent vector si(ts) on the trajectory Si is close enough to the vector vᵢ^{out} (i.e., the distance between si(t) and vᵢ^{out}, D(t)=||si(t)−vᵢ^{out}||≤ρ. Note that ρ is the transition strength, which is an example of the transition condition.

### Model 2

Let s(t) be the latent vector at time point t. The dynamic space transition from regime θi to regime θj can be described by the following Mathematical 2.

$$\begin{matrix}[ Mathematical 2 ] & \\ s ( t ) = \{ \begin{matrix}{s}_{i} ( t ) & ( 1 \leq t < {t}_{s} ) // staying in regime {θ}_{i} \\ {v}_{j}^{in} & ( t = {t}_{s} ) // transition from {θ}_{i} to {θ}_{j} \\ {s}_{j} ( t ) & ( {t}_{s} < t ) // staying in regime {θ}_{j}\end{matrix} , & ( 3 ) \\ such that {t}_{s} = {arg min}_{t \vert D ( t ) \leq ρ} D ( t ) , & \\ where , D ( t ) = ‖ {s}_{i} ( t ) - {v}_{i}^{out} ‖ shows the distance between two vectors {s}_{i} ( t ) and {v}_{i}^{out} . Here , {s}_{i} ( t ) is the latent vector generated by {θ}_{i} at time point t , and \{ {v}_{i}^{out} , {v}_{j}^{in} \} is a transition vector pair from {θ}_{i} to {θ}_{j} . & \end{matrix}$$

In these equations, D(t)=||si(t)−vᵢ^{out}|| indicates the distance between the two vectors si(t) and vᵢ^{out}. Here, si(t) is the latent vector generated by θi at time point t, and {vᵢ^{out}, vⱼⁱⁿ} is a transition vector pair from θi to θj.

Also, let ν be the transition vector set of the transition vector pair {vᵢ^{out}, vⱼⁱⁿ}∈ν(i,j=1, . . . , r).

There may be multiple out-vector vᵢ^{out}s on the same trajectory/orbit. In this case, the model chooses the closest out-vector and moves from the selected out-vector to another regime (in- vector in the regime). Also, each regime pair has multiple transition vector pairs {vᵢ^{out}, vⱼⁱⁿ} (as shown in FIG. 6B, regime pairs θ1 and θ2 have two different transition arrows). Thus, different trajectories may cause completely different space transitions.

FIG. 6C shows how OrbitMap produces long-term multi-step space transitions. Given an initial vector v₁ⁱⁿ, it causes space transitions (i.e., regime θ1→θ2→θ3→θ4), where each regime generates a set of latent/estimated sequences according to the above Models 1 and 2 (i.e., {S1, E1}, . . . , {S4, E4}).

Let M be a complete set of OrbitMap parameters, i.e. M={Θ, ν}, where Θ consists of a set of r regimes, that is, Θ={θ1, . . . , θr}, and ν is a transition vector set, that is, {vᵢ^{out}, vⱼ^{in}∈ν.}

The above shows how this model captures time-evolving patterns (i.e., regimes) and their latent relationships (i.e., dynamic space transitions) in a data stream X.

Next the following describes a streaming algorithm. Table 1 shows symbols and definitions used.

TABLE 1
Table ₁: Symbols and definitions.

| Symbol | Definition |
|---|---|
| X | Time-evolving data stream, i.e., X = {x (1), . . . , x (t)} |
| x (t) | d-dimensional vector at time point t, i.e., x (t) = {xi (t)}ᵢ^{d}₌₁ |
| S | Latent variables, i.e., S = {s(1), . . . , s (t))} |
| E | Estimated variables, i.e., E = {e(1), . . . , e(t))} |
| Θ | Model parameter set of r regimes, i.e., Θ = {θ₁, . . . , θᵣ} |
| [symbol] | Transition vector set, i.e., {vᵢ^{out}, vⱼⁱⁿ} ϵ [symbol] |
| M | Complete set of ORBITMAP, i.e., M = {Θ, [symbol] } |

First, (a) determines a way to find an optimal parameter set M={Θ, ν} in a real data stream X, and (b) describes how to apply the selected model (mathematical model) to real-time forecasting. Data stream X ={x(1), . . . , x(tc)}, where x(tc) is the most recent value at time point tc.

For (a), the parameter set M={Θ, ν} is maintained incrementally, and the regime set Θ in the data stream X and their transition vector pairs are acquired. For (b) to forecast long-term future patterns, a model is updated while adjusting parameters and also lₛ-step-ahead future value e(tc+lₛ) is forecasted using the dynamic modeling framework.

The following describes Orbit-Map-F, which will be equipped with a streaming algorithm that achieves the above (a) and (b). This algorithm estimates the model parameters of regimes and extracts information about space transitions in X, and forecasts future event values simultaneously in a streaming fashion.

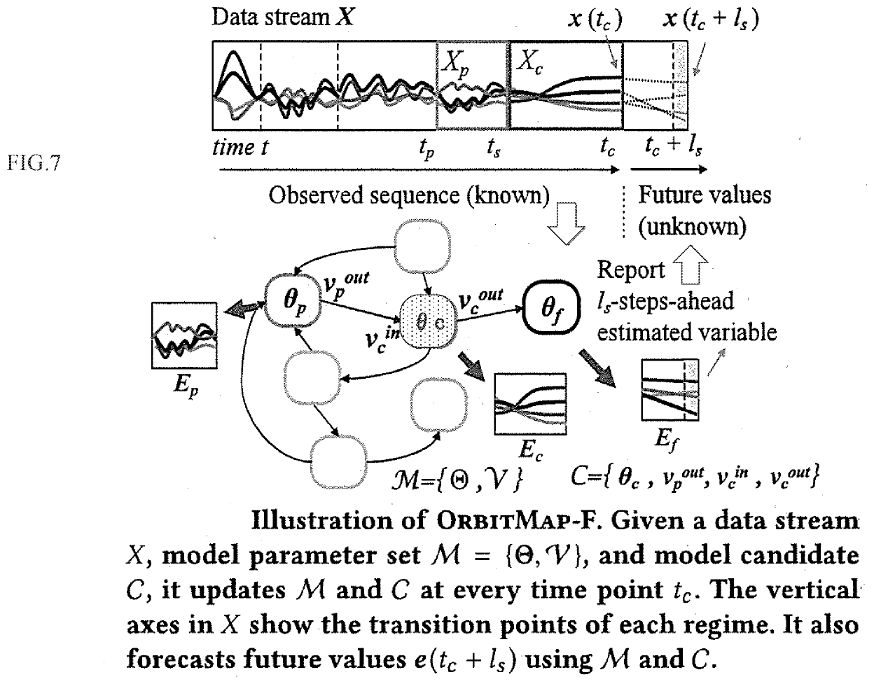

FIG. 7 is a snapshot of the orbit at time point tc. This dynamic modeling framework constructs, stores, and uses a space transition network between regimes, which provides long-term forecasts with high accuracy, by following the paths of transitions.

The idea of this algorithm is to monitor X and keep track of two regimes, the pre-transition regime θp and the current candidate regime θc. Specifically, at every time point tc, given a data stream X, it monitors the current segment Xc=X[ts: tc] (i.e., the recent subsequence of X), which is assigned to regime θc.

While checking the end point of Xc (i.e., whether or not the current regime θc should be replaced by another regime (e.g., θf)), the algorithm estimates the candidate regime θc and its transition vectors between θp and θc (i.e., vₚ^{out}, v_{c}ⁱⁿ, v_{c}^{out}). Then, the algorithm keeps them as the model candidate C={θc, vₚ^{out}, v_{c}ⁱⁿ, v_{c}^{out}} for stream processing. It also forecasts the lₛ-step-ahead future value e(tc+lₛ) using M and C, according to the models 1 and 2 as stated above.

Next, the following describes parameter estimation for a single regime θc. Here, the algorithm uses model 1 and estimates optimal parameters using mathematical 3 so as to minimize the fitting error between the original segment Xc=X[ts: tc] and the estimated variable Ec=E[ts: tc] generated by {θc, v_{c}ⁱⁿ, v_{c}^{out}}

$$\begin{matrix}[ Mathematical 3 ] & \\ \{ {θ}_{c}^{*} , {v}_{c}^{i {n}^{*}} , {v}_{c}^{o u {t}^{*}} \} = {arg min}_{{θ}_{c} , {v}_{c}^{i n} , {v}_{c}^{o u t}} {f}_{D} ( {X}_{c} ; {θ}_{c} , {v}_{c}^{i n} , {v}_{c}^{out} ) , & \end{matrix}$$

In the equation, fD(·) shows the fitting error between the original variable and the estimated variable. This is represented by Mathematical 4.

fD(Xc·θc,v_{c}ⁱⁿ,v_{c}^{out})=93 ^{tc}ₜ₌ₜₛ||x(t)−e(t)|| [Mathematical 4]

The Levenberg-Marquardt (LM) algorithm and the Runge-Kutta method are used to estimate the parameters. Note that the vector pair v_{c}ⁱⁿ and v_{c}^{out} corresponds to the latent variables at time points is and tc, respectively. That is, v_{c}ⁱⁿ=s(ts) and v_{c}^{out}=s(tc).

Next, the following describes streaming algorithms OrbitMap-F. This algorithm includes the following sub-algorithms (a)-(c).

(a) Estimates a complete parameter set M and the model candidate C. (O-Estimator: OrbitMap)

(b) Generates an lₛ-step ahead future value, i.e., e(tc+lₛ), using M and C. (O-Generator)
(c) Cleans up (removes) useless regimes and transitions stored in M (if required). (O-Feedback)

TABLE 2
Algorithm 1 ORBITMAP-F (x(t_{c}), [symbol] , C)

| | | |
|---|---|---|
| 1: | Input: | (a) New value x(t_{c}) at time point t_{c} |
| | | (b) Current ORBITMAP parameter set [symbol] = {Θ, [symbol] } |
| | | (c) Model candidate C = {θ_{c}, υₚ^{out}, υ_{c}ⁱⁿ, υ_{c}^{out}} |
| 2: | Output: | (a) Updated ORBITMAP parameter set [symbol] ′ |
| | | (b) Updated model candidate C′ |
| | | (c) lₛ-steps-ahead future value e(t_{c} + lₛ) |

| | |
|---|---|
| 3: | /* (I) ORBITMAP estimation and segmentation */ |
| 4: | { [symbol] ′, C′} = O-ESTIMATOR(x(t_{c}), [symbol] , C); |
| 5: | /* (II) lₛ-steps-ahead future value forecasting */ |
| 6: | e(t_{c} + lₛ) = O-GENERATOR( [symbol] ′, C′, lₛ); |
| 7: | /* (III) ORBITMAP feedback (if required) */ |
| 8: | [symbol] ′ = O-FEEDBACK( [symbol] ′); |
| 9: | return { [symbol] ′, C′, e(t_{c} + lₛ)}; |

algorithm incrementally updates the parameter set M and the model candidate C using the O-Estimator, and then generates an lₛ-step-ahead future value e(tc+lₛ) with O-Generator. It also manages the OrbitMap parameters by using O-Feedback. This cleans up the useless regimes and transitions stored in M.

Next, the following describes Algorithm 1 in more detail. The first step is O-Estimator. This monitors the time-series data stream X and identifies the current regime in this data stream X. O-Estimator acquires the latest value x(tc) at time point tc. O-Estimator incrementally updates the parameter set M and the model candidate C.

TABLE 3
Algorithm 2 O-ESTIMATOR (x(t_{c}), [symbol] , C)

| | |
|---|---|
| 1: | Input: (a) New value x(t_{c}) at time points t_{c} |
| | (b) Current ORBITMAP parameter set [symbol] = {Θ, [symbol] } |
| | (c) model candidate C = {θ_{c}, υₚ^{out}, υ_{c}ⁱⁿ, υ_{c}^{out}} |
| 2: | Output: (a) Updated ORBITMAP parameter set [symbol] ′ |
| | (b) Updated model candidate C′ |
| 3: | X_{c} = X[tₛ : t_{c}]; // Update current segment X_{c} |
| 4: | /* (I) Estimate current regime */ |
| 5: | /* Update current regime for X_{c}, using model candidate C */ |
| 6: | $\{ {θ}_{c} , {υ}_{c}^{i n} , {υ}_{c}^{out} \} = {arg max}_{{θ}_{c} , {υ}_{c}^{in} , {υ}_{c}^{out}} {f}_{D} ( {X}_{c} ; {θ}_{c} , {υ}_{c}^{in} , {υ}_{c}^{o u t} ) ;$ |
| 7: | if f_{D} (X_{c}; θ_{c}, υ_{c}ⁱⁿ, υ_{c}^{out}) > ρ then |
| 8: | /* If the current regime does not fit well, find a better regime |
| | in Θ */ |
| 9: | $\{ {θ}_{c} , {υ}_{c}^{i n} , {υ}_{c}^{out} \} = {arg max}_{θ ∈ Θ , {υ}^{in} , {υ}^{out}} {f}_{D} ( {X}_{c} ; θ , {υ}^{in} , {υ}^{o u t} ) ;$ |
| 10: | if f_{D}(X_{c}; θ_{c}, υ_{c}ⁱⁿ, υ_{c}^{out}) > ρ then |
| 11: | /* If it is still not good, create new regime and insert it into Θ */ |
| 12: | {θ_{c}, υ_{c}ⁱⁿ, υ_{c}^{out}} = REGIMECREATION(X_{c}); Θ = Θ ∪ θ_{c}; |
| 13: | end if |
| 14: | end if |
| 15: | /* (II) Detect space transition */ |
| 16: | if f_{D}(X_{c}; θ_{c}, υ_{c}ⁱⁿ_{,} υ_{c}^{out}) > ρ then |
| 17: | /* If it does not fit well, current segment X_{c} ends now */ |
| 18: | [symbol] = [symbol] ∪ {υₚ^{out}, υ_{c}ⁱⁿ}; // Insert new transition pair into [symbol] |
| 19: | υₚ^{out} = υ_{c}^{out}; // Replace previous out-vector |
| 20: | X_{c} =x(t_{c}); θ_{c} = υ_{c}ⁱⁿ = υ_{c}^{out} = θ; // Initialize segment and regime |
| 21: | end if |
| 22: | [symbol] ′ = {Θ, [symbol] }; // Update model parameters |
| 23: | C′ = {θ_{c}, υₚ^{out}, υ_{c}ⁱⁿ, υ_{c}^{out}}; // Update model candidate |
| 24: | return { [symbol] ′, C′}); |

Algorithm 2 shown in Table 3 is the algorithm of O-Estimator. To reduce the computation time in the streaming setting, an insertion-based approach for updating M is used. That is, O-Estimator includes two parts: (I) update the current regime and (II) detect a space transition.

(I) Update the current regime:

Given the current segment Xc and model candidate C, the algorithm first tries to update the current regime θc, i.e., with the operation of Mathematical 3 above. This minimizes the errors between Xc and θc. If the minimum error cannot be adjusted below the condition level of regime change, that is, if the current regime θc does not fit well (i.e., fD(Xc)>ρ), then the algorithm searches for another (better) regime θ∈Θ stored in M. If it is still not enough (i.e., there is not appropriate regime in M), the algorithm creates a new regime for Xc using RegimeCreation, and inserts it into M. In this case, ρ may be used as a condition for changing the regime, or a dedicated decision value may be adopted.

(II) Detect a space transition (if any):

After the algorithm has estimated the current parameter set {θc, v_{c}ⁱⁿ, v_{c}^{out}}, it then tries to find a space transition. If it cannot find or create any well-fitting regime (i.e., fD (Xc)>ρ), it terminates the current segment Xc and its regime θc and starts a new segment Xc=x(tc). It also inserts the transition vector pair {vₚ^{out}, v_{c}ⁱⁿ} into ν. After the insertion, it replaces the previous out-vector vₚ^{out}=v_{c}^{out} and resets it as regime θc=v_{c}^{in=v}_{c}^{out}=0.

Next, the following describes creation and insertion of a new regime. When the algorithm finds an unknown pattern in Xc, it needs to create a new regime and estimate its model parameter set θ using Xc. Here, each regime θ includes a large number of parameters (i.e., θ={p, Q, A, u, V}), and computation cost is required to optimize them all simultaneously. Thus, this embodiment uses an efficient and effective optimization method, that is, the algorithm of RegimeCreation. The idea is splitting a complete parameter set θ into two subsets, i.e., θL ={p, Q, u, V} and θN={A}, each of which corresponds to a linear/non-linear parameter set, and fit the parameter sets separately. Here, the embodiment uses the expectation-maximization algorithm to optimize the linear parameters θL. It then estimates non-linear elements in θN and vⁱⁿ, v^{out} to minimize the distance fD(Xc; θ, vⁱⁿ, v^{out}), using the Levenberg-Marquardt (LM) algorithm and the Runge-Kutta method. The embodiment repeats a similar process while varying k so as to minimize the fitting errors, and determines appropriate models.

Next, the following describes the algorithm of the O-Generator. This forecasts an lₛ-step-ahead future value e(tc+lₛ), by using the parameter set M and the model candidate C, which are estimated by O-Estimator. The idea is quite simple and efficient: given the current regime θc and its estimated in-vector v_{c}ⁱⁿ for the recent segment Xc, the embodiment computes an lₛ-step-ahead future value e(tc+lₛ), according to models 1 and 2. Specifically, O-Generator involves three steps (I)-(III).

(I) Given the current regime θc and its initial vector v_{c}ⁱⁿ, the algorithm first generates lₛ-step-ahead future latent variables s={sc(tc), . . . , sc(tc+lₛ,)), where sc(tc)=v_{c}ⁱⁿ.

(II) Next, the algorithm finds any transition vector pair (v_{c}^{out}, v_{f}ⁱⁿ)∈ν that is close to the trajectory of S. If the trajectory of S is close enough to the vector v_{c}^{out} (i.e., ||sc(ts)−v_{c}^{out}||≤ρ, tc≤ts≤tc+lₛ), it moves the trajectory to another regime θf at time point ts. Consequently, the algorithm generates the latent variable S={sc(tc), . . . , sc(ts−1), v_{f}ⁱⁿ, sf(ts+1), . . . , sf(tc+lₛ)}, and updates M.

(III) Given the latent variables S generated by (I) and (II) above, the algorithm computes estimated variable E using θc (and θf, if any transition) according to Model 1. Next, the algorithm then returns the future value e(tc+lₛ) to an lₛ-step-ahead future.

If the same regimes and their transitions appear more than once in the data stream X, OrbitMap-F can memorize/store the number information in the space transition network in M, and reuse them efficiently to forecast future dynamics. In one example, preferably, the one with the larger number information is preferentially used.

Next, the following describes (a) how to determine the optimal transition strength ρ, and (b) how to eliminate noise or meaningless regime information stored in the complete parameter set M. For (a), the regime creation and segmentation rely on transition strength ρ. This corresponds to the prediction accuracy between the original data streams and the estimation. The transition strength ρ also affects the network complexity of M, where the lower variable creates a more complex network (i.e., more regimes and transitions). This embodiment updates ρ and creates the optimal transition network that can best describe the current activities in the data stream, so that it can forecast lₛ-step-ahead future values. Thus, the lₛ-step-ahead forecasting error between the original value and the estimation can be calculated by mathematical 5.

arg min ρΣ^{tc}ₜ₌₁||x(t+1)−e(t+lₛ)|| [Mathematical 5]

That is, the optimum ρ for minimizing Mathematical 5 may be calculated.

Next, (b) is a cleanup process for the parameter set M. In practice, data streams might contain various types of noise or meaningless patterns that should be ignored. Also, if transition strength ρ is tuned to be a larger variable, it is desirable to shrink the transition network of M by grouping similar regimes/nodes together. The embodiment thus introduces a cleansing function, which incrementally maintains and updates information on regimes and their transitions in M, that is, organizes the information. The cleansing function is preferably automatic, and it includes two sub-functions: (a) regime elimination, that is, it searches for regimes that have never been used or have been infrequently used by O-Estimator, so to speak, that satisfy an elimination condition in the parameter set storage 103, and eliminates them from the parameter set storage 103; (b) transition network shrinkage, it searches for all the closest regime pairs θi and θj, whose estimation error between each other is less than ρ in the parameter set storage 103, and merges them.

### Experiments

Next the following describes experiments and their results. The experiments were conducted using real datasets on the effectiveness of the algorithms of OrbitMap. The experiments were designed to answer the following questions:

(Q1) Effectiveness: How successful is the method in modeling and forecasting long-term dynamics in given input streams?

(Q2) Accuracy: How well does the method forecast future values?

(Q3) Scalability: How does the method scale in terms of computational time?

The experiments were conducted on an Intel Core i7-3770K 3.50 GHz with 32 GB of memory, running Linux(R).

(Q1): Effectiveness: this demonstrates the modeling power of Orbit-Map in terms of capturing important patterns in data streams and forecasting future values. The experiments were conducted on eight data streams, in multiple domains, e.g., environmental, machine, human sensors and online social user activities. To ensure the repeatability of our results, the experiments used several publicly available datasets.

The experiments were also conducted on real IoT data streams in smart factories belonging to several companies. Here, the results for the (#1) Factory-worker dataset only were described below. This dataset consists of d=4 acceleration sensors (100 Hz), attached to the right/left legs and arms of a worker in a factory. FIGS. 4A, 4B, 4C, and 4D the OrbitMap output. As already seen, this method automatically and incrementally captures (a) typical regimes (e.g., walking and lifting) in a given stream, (b) their transition points (see vertical axis in FIG. 4B), and (c) dynamic transition network (e.g., lifting→wiping). Most importantly, the transition network grows over time, as a new regime or transition appears in the stream. Since OrbitMap can continuously capture dynamic regimes and their transitions, it also enables real-time future value forecasting.

FIG. 4D shows the real-time forecasting results. Specifically, OrbitMap forecasts an lₛ=200-steps-ahead future value, for every time point. The output of this method with other datasets will be shown later.

(Q2) Next, for accuracy, the following describes the quality of OrbitMap in terms of lₛ-step-ahead forecasting accuracy. Here this method was compared with the following methods: For example, comparison was made with (a) RegimeCast, which is a real-time forecasting algorithm for data streams, (b) SARIMA, and (c) TBATS, which are a linear prediction methods. Comparison was also made with (d) LSTM and (e) GRU, which are recurrent neural network (RNN) models with long short-term memory (LSTM) cells and gated recurrent units (GRUs), respectively. For all methods, the parameters were trained using half of the sequence and then the future value prediction was started.

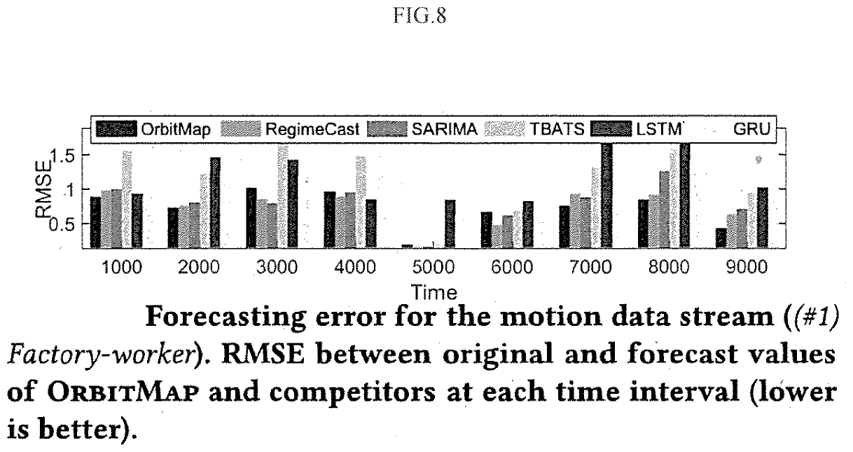

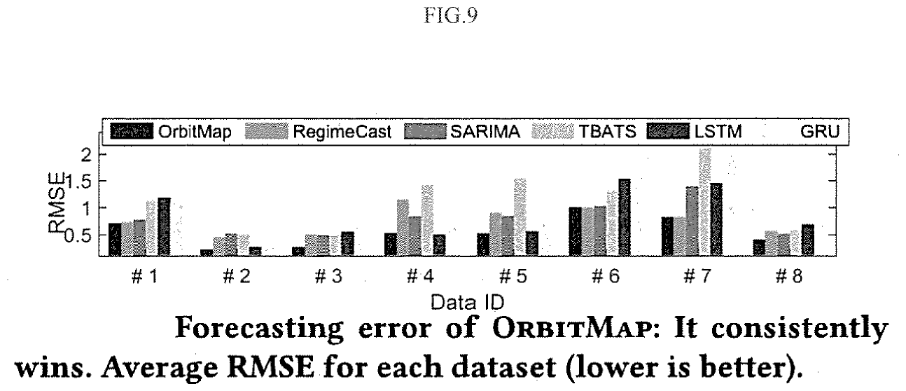

FIG. 8 shows the forecasting error of OrbitMap for Factory-worker in a motion data stream. Specifically, FIG. 8 shows the root mean square error (RMSE) between the original value x(tc+lₛ) and the lₛ-step-ahead estimated variables e(tc+lₛ) at each time interval. A lower value indicates a better forecasting accuracy. Similarly, FIG. 9 shows the average forecasting error of OrbitMap and its competitors for eight datasets (#1-#8). In FIGS. 8 and 9, the arrangement order of the algorithms described in the uppermost row matches the arrangement order of the bar graphs.

According to FIGS. 8 and 9, the method achieves a high forecasting accuracy for every dataset, while other methods cannot forecast future evolutions very well because they cannot capture multiple distinct regimes and their space transitions.

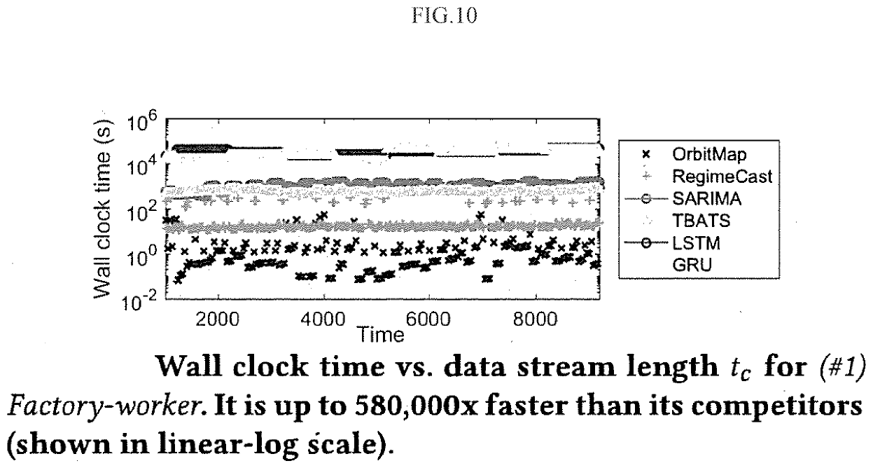

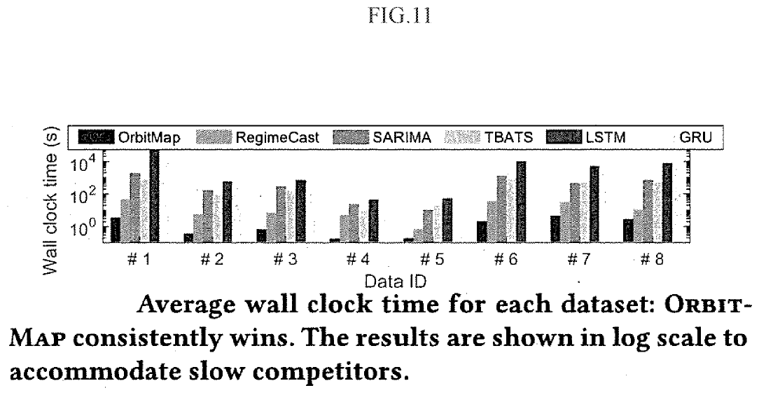

(Q3) Next, for scalability, the following evaluates the efficiency of the algorithm of this method. FIG. 10 compares OrbitMap with its competitors in terms of computation time at each time point tc. Note that FIG. 10 is shown on a linear-log scale. The algorithm of this method can monitor a data stream for at least 0(1) time and at most O(r) time per time point. In fact, OrbitMap, which is plotted with an X in the figure, is significantly (i.e., up to five orders of magnitude) faster than its competitors for large streams. FIG. 11 shows the average computation time at each time point for eight datasets (#1-#8). In FIG. 11, the arrangement order of the algorithms described in the uppermost row matches the arrangement order of the bar graphs. This method provides a quick response, and achieves a large reduction in both computation and forecasting errors.

The following describes one of the applications, that is, real-time mining in smart factories.

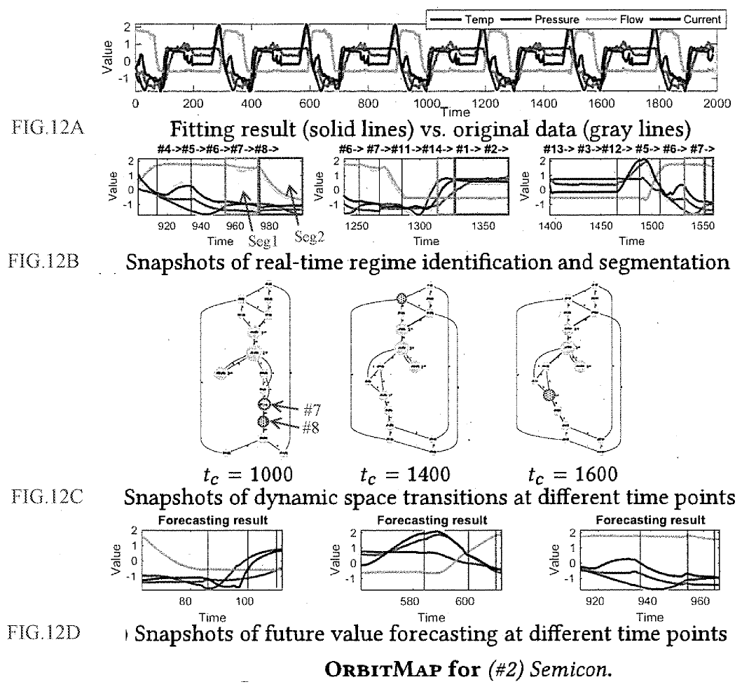

FIGS. 12A, 12B, 12C, and 12D show operational monitoring, especially a four-dimensional IoT sensor stream in a semiconductor fabrication plant. Each dimension is composed of “pad temperature”, “airbag pressure”, “atomizer flow”, and “table motor current” so as to correspond to the upper row of FIG. 12A. Since wafer processing is very sensitive and the company needs to produce high quality wafers, it is critical to keep the machines in good conditions by carefully monitoring the current state in the sensor streams.

The use of the modeling approach according to the present invention makes it possible to monitor the sensor streams in the factory, and provides visualization of the regular CMP processes. FIGS. 12B and 12C show the regime identification and transition network at three different time points (tc=1000, 1400, 1600). Here, the shaded nodes and the chains between them indicate the transitions of the two latest regimes. The relationship between FIGS. 12B and 12C will be explained using, for example, the leftmost diagram of FIG. 12B. When the stream frames of the latest two regimes are represented by Seg1 and Seg2, the regime “#7” corresponds to Seg1 in the transition network in the leftmost figure (tc=1000) in FIG. 12C, and the regime “#8” corresponds to Seg2, which shows the transition relationship between the latest two regimes.

This method successfully captures the sensitive and precise procedures of the CMP machine, such as the up/down patterns of the airbag pressure and motor current, the cooling down process and atomizer flows. Also, as shown by the transition network in FIG. 12C, the graph structure is unique: it has a long chain consisting of multiple distinct nodes as shown. This indicates that the data stream consists mainly of regular, repeating patterns. Consequently, using the OrbitMap modeling in this method, factory managers can remotely and automatically monitor and analyze sensitive machine performance, and can plan a regular maintenance schedule, predict potential accidents and more. In addition, this scalable algorithm allows the real-time forecasting of future values. FIG. 12D shows 10-steps-ahead future values at three different time points. The vertical axis (i.e., tc, tc+lₛ) shows the current and lₛ-step-ahead time points, and the method successfully captures future dynamic regime transitions, and forecasts long-term multi-step future patterns.

Next, the following describes another case of IoT data monitoring, such as machine downtime prediction. Manufacturing problems, such as faulty goods and equipment failure, are caused by various factors. This method automatically detects these factors. That is, the method detects the cause of problems in real time, and uses this information to improve productivity and quality and optimize the manufacturing process in smart factories. For example, an IoT data stream collected by a computerized numerical control (CNC) machine in an internal combustion engine plant was used.

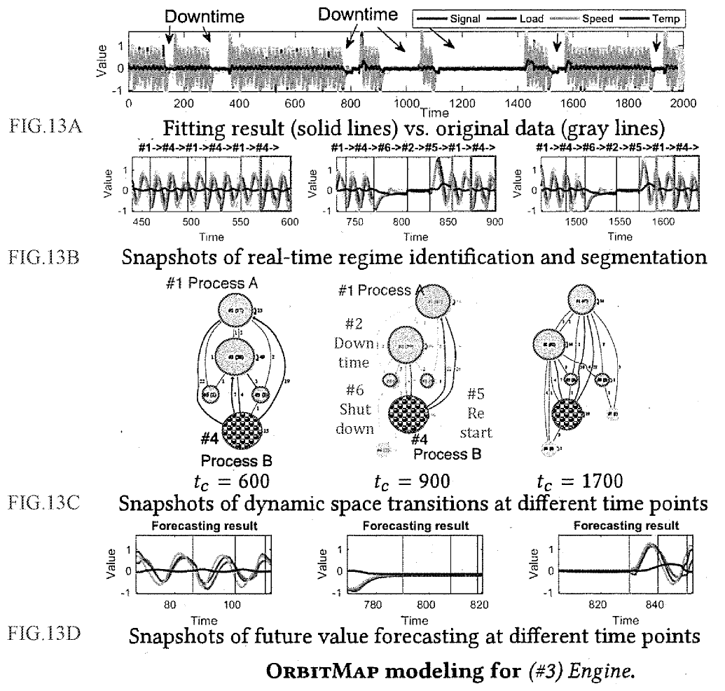

FIG. 13A, shows the original data stream and the estimated values. The method used four sensors: operation signal, spindle load, spindle speed, and spindle temperature. The data stream contains several regularly repeated activities (e.g., up/down patterns of spindle temperature and speed), and it also has some downtime (see arrows in FIG. 13A). FIGS. 13B and 13C show OrbitMap output at three different time points. The leftmost figures in FIGS. 13B and 13C show normal operation activities at time t=600, with two types of regimes (#1→#4→#1→#4→ . . . ), while the middle and right figures show snapshots at time t=900, 1700, with downtime patterns. Most importantly, the method is able to observe the same transitions for each downtime activity, i.e., #6→#2→#5→#1→ . . . .

Each regime corresponds to #6 “shutdown” (slowing down the spindle speed, and cooling down the machine), #2 “downtime” (stopping the spindle with a stable temperature), and #5 “restart” (starting the spindle). After that, it becomes #1 “process-A” (normal operation). Consequently, using this method of regime identification and dynamic transition network, the manager can incrementally check the machine condition, and avoid machine downtime as well as reduce extra cost or prevent accidents in advance. This method captures future unknown patterns, and forecasts future values in an incremental and adaptively.

In another aspect, the forecasting apparatus 1 may impart a reception time when data is received from the sensors 2.

Time series (big) data that can be applied to the present invention can include various types of data that continue to be generated in large quantities in various domains and in various fields, such as vehicle and transportation systems, various sensor networks represented by IoT, quality monitoring in smart factories, user activity in Web services, and biometric information in the medical field.

As described above, a forecasting apparatus according to the present invention includes a regime update unit configured to perform optimization processing that applies a candidate regime to an event stream in a most recent current window, and adjusts a parameter of a model of the applied regime to reduce a difference from an event; a forecasting unit configured to use the model subjected to the optimization processing by the regime update unit to forecast future event information; and a storage that stores transition information that indicates transition history between regimes. Preferably, the regime update unit determines whether or not the regime being applied satisfies a transition condition, and if the determination is affirmative, uses the transition information for the regime being applied that is stored in the storage to let the regime transition.

A forecasting method according to the present invention includes: a regime updating step of performing optimization processing that applies a candidate regime to an event stream in a most recent current window, and adjusts a parameter of a model of the applied regime to reduce a difference from an event; a forecasting step of using the model subjected to the optimization processing by the regime updating step to forecast future event information; and a storage step of storing transition information that indicates transition history between regimes. Preferably, the regime updating step determines whether or not the regime being applied satisfies a transition condition, and if the determination is affirmative, uses the transition information for the regime being applied that is stored in the storage to let the regime transition.

A program according to the present invention makes a computer function as the forecasting apparatus.

According to these aspects of the invention, the regime update unit performs optimization processing that applies a candidate regime to an event stream in a most recent current window, and adjusts a parameter of a model of the applied regime to reduce a difference from an event; the forecasting unit uses the model subjected to the optimization processing by the regime update unit to forecast future event information; and the storage stores transition information that indicates transition history between regimes. Then, the regime update unit determines whether or not the regime being applied satisfies a transition condition, and if the determination is affirmative, uses transition information for the regime being applied that is stored in the storage to let the regime transition. Therefore, a regime change (shift) is made using transition information that indicates the transition history between the regimes stored in advance, which improves responsiveness, adaptability, and accuracy of (regime) forecasting between different regimes. As a result, responsiveness and accuracy for future forecasting are improved.

Preferably, the transition condition is that a distance between a latent vector and a transition vector in the regime being applied is a predetermined value or less. According to such a configuration, a latent vector is continuously generated for the regime being applied, and it is determined whether or not the distance between the latent vector and the transition vector in the same regime is the predetermined value or less. A regime transition is then determined based on the result. Therefore, the regime transition is determined according to the calculation result.

Preferably, the forecasting apparatus of the present invention includes a regime insertion unit configured to create a transition history of the regime applied by the regime update unit as the transition information and update the transition information in the storage. This configuration allows, when a new unknown regime is found, this regime to be additionally registered in the storage to be available, thus increasing the number of regimes that can be supported.

Preferably, the regime insertion unit creates a set of two or more regimes as the transition information. This configuration allows the set of regimes to be three, four or more, in addition to the two regimes (regime pair) corresponding to before and after the transition, and the forecasting performance increases with the number of regimes.

Preferably, the transition information includes a transition vector pair that is an out-vector and an in-vector between the regimes, and the forecasting unit makes a transition from an out-vector of a regime before a transition to an in-vector of a regime after the transition. This configuration registers not only the set of regimes before and after the transition but also the transition vector of the regimes before and after the transition, which improves the transition accuracy more.

### REFERENCE SIGNS LIST

1 Forecasting apparatus

10 Controller (computer)

11 Current window calculation unit

12 Regime update unit

13 Regime insertion unit

14 Forecasting unit

103 Parameter set storage (storage)

1. A forecasting apparatus comprising:
a regime update unit configured to perform optimization processing that applies a candidate regime to an event stream in a most recent current window, and adjusts a parameter of a model of the applied regime to reduce a difference from an event;
a forecasting unit configured to use the model subjected to the optimization processing by the regime update unit to forecast future event information; and
a storage that stores transition information that indicates transition history between regimes,
the regime update unit determining whether or not the regime being applied satisfies a transition condition, and if the determination is affirmative, using the transition information for the regime being applied that is stored in the storage to let the regime transition.

2. The forecasting apparatus according to claim 1, wherein the transition condition is that a distance between a latent vector and a transition vector in the regime being applied is a predetermined value or less.

3. The forecasting apparatus according to claim 1, comprising a regime insertion unit configured to create a transition history of the regime applied by the regime update unit as the transition information and update the transition information in the storage.

4. The forecasting apparatus according to claim 3, wherein the regime insertion unit creates a set of two or more regimes as the transition information.

5. The forecasting apparatus according to claim 1, wherein
the transition information includes a transition vector pair that is an out-vector and an in-vector between the regimes, and
the forecasting unit makes a transition from an out-vector of a regime before a transition to an in-vector of a regime after the transition.

6. A forecasting method comprising:
regime updating by applying a candidate regime to an event stream in a most recent current window, and adjusting a parameter of a model of the applied regime to reduce a difference from an event;
forecasting future event information by using the model adjusted by the regime updating; and
storing transition information that indicates transition history between regimes, in a storage,
the regime updating determining whether or not the regime being applied satisfies a transition condition, and if the determination is affirmative, using transition information for the regime being applied that is stored in the storage to let the regime transition.

7. A non-transitory computer readable medium including a program causing performance of:
regime updating by applying a candidate regime to an event stream in a most recent current window, and adjusting a parameter of a model of the applied regime to reduce a difference from an event;
forecasting future event information by using the model adjusted by the regime updating; and
storing transition information that indicates transition history between regimes, in a storage,
the regime updating determining whether or not the regime being applied satisfies a transition condition, and if the determination is affirmative, using transition information for the regime being applied that is stored in the storage to let the regime transition.
